(19) United States
(12) Patent Application Publication
(10) Pub. No.: US 2019/0152592 A1
(43) Pub. Date: May 23, 2019

(54) ALMOST LIGHTER THAN AIR VEHICLE

(71) Applicants: Brent HARPER, Pescadero, CA (US); Thomas Rock MACKIE, Verona, WI (US); Timothy HOLZMANN, Madison, WI (US)

(72) Inventors: Brent HARPER, Pescadero, CA (US); Thomas Rock MACKIE, Verona, WI (US); Timothy HOLZMANN, Madison, WI (US)

(21) Appl. No.: 16/046,543

(22) Filed: Jul. 26, 2018

Related U.S. Application Data
(63) Continuation of application No. PCT/US2017/015347, filed on Jan. 27, 2017.
(60) Provisional application No. 62/287,893, filed on Jan. 27, 2016.

(51) Int. Cl. B64C 27/20; B64D 37/04; B64C 27/52; B64B 1/30

(52) U.S. Cl. CPC B64C 27/20; B64D 37/04; B64C 39/001; B64B 1/30; B64C 27/52

(57) ABSTRACT

Some embodiments described herein relate to an aircraft that includes a support frame, at least one gas compartment, and multiple propulsion units. The gas compartment(s) can be coupled to the support frame and configured to contain a gas having a gas density less than the density of atmospheric air surrounding the aircraft during operation. Similarly stated, the gas-filled gas compartment(s) can produce a gas lifting force on the support frame. The propulsion units can each be configured to selectively produce a propulsive force with a thrust vector with a non-zero component along a vertical axis of the support frame. The maximum gross weight of the aircraft can be greater than either the gas lifting force of the maximum vertical propulsion force and less than the sum of the gas lifting force and the maximum vertical propulsion force.

### CROSS-REFERENCE TO RELATED APPLICATIONS

This application is a continuation of International PCT Application No. PCT/US2017/015347, entitled “Almost Lighter Than Air Vehicle,” filed Jan. 27, 2017, which claims the benefit of provisional U.S. Patent Application No. 62/287,893, entitled “Almost Lighter Than Air Aircraft,” filed on Jan. 27, 2016, the disclosure of each of which is hereby incorporated by reference in its entirety.

### TECHNICAL FIELD

The present disclosure relates to aircraft in general, and to an almost lighter than air aircraft in particular.

### BACKGROUND

Traditional aircraft include Lighter-Than-Air (“LTA”) aircraft that generate lift by using a volume of gas that is less dense than the ambient atmosphere air, based on lower molecular weight (such as hydrogen or helium) and/or based on higher temperature (such as hot air). Heavier-Than-Air (“HTA”) aircraft generate lift by using rotating airfoils (e.g. helicopters), turbines or propellers to provide thrust and aero foils to provide lift (e.g. conventional fixed wing aircraft). More recent HTA aircraft include primarily vertical axis, multi-rotor design, e.g. “quadcopters,” often referred to as “drones.”

The primary barrier to personal, point-to-point aircraft is not supply or demand, but safety. There are significant safety issues for the occupants, terrestrial bystanders, and other aircraft. These safety issues are proportional to the energy (kinetic and potential) associated with the flight of the aircraft and are closely tied to mass, gravity, and velocity. HTA aircraft require significant horizontal velocity in order for their wings or other lifting surfaces to provide sufficient lift, and control of the craft at landing and takeoff requires considerable skill. The rigid nature and mass of the wings, fuselage, and motor(s) all increase the potential damage to bystanders and property. Moreover, known aircraft, both HTA and lighter-than-air (“LTA”), are constructed such that, when landing (e.g., controlled, uncontrolled, or partially controlled) rigid structures, such as fuselages or cupolas make first contact with the ground. The combination of this mass and velocity lead to significant kinetic energy and rigid structures that impart considerable impulses in the event of a collision.

The nature of flight also demands some altitude and the mass and gravity add potential energy to the kinetic energy of the aircraft. The dangers for a motor failure for HTA are serious and regulatory bodies, such as the United States Federal Aviation Administration (“FAA”) have promulgated many regulations for aircraft design, manufacture, pre-flight, flight, and glide operation. There are so many regulations for commercial aircraft that the FAA has created exceptions for small, personal aircraft under the “sport aircraft” designation. Sport aircraft must have a gross weight less than 600 kg. This mass limit is more for the safety of terrestrial bystanders and property than for the pilot. It is the safety of terrestrial bystanders that becomes the primary barrier to large-scale deployment of personal aircraft from a regulatory and safety perspective.

In order for personal aircraft to be approved for broad-scale deployment, the aircraft must meet some very demanding requirements. First and foremost, it must be safe, and it must be safe for the occupants, other aircraft, and terrestrial bystanders. There are many ways to approach this problem. The most straight-forward safety mechanism is a system that never fails, but this is not a realistic approach for any mechanical system. Single point failures will occur and there must be a redundant safety system. Most redundant safety systems are unacceptable. Vehicle parachutes (e.g. ballistic recovery systems) are problematic because they require ground clearance to deploy, add significant weight, and the vehicle still provides significant danger to bystanders on the ground. Backup power and redundant thrust mechanisms are unacceptable because they add significant weight and complexity. Impact air bags also add significant weight and still provide significant danger to bystanders on the ground. Unpowered landings can be acceptable but for HTA they require sufficient glide distance and the availability of adequate landing area and pose a significant danger to bystanders on the ground. A preferred redundant safety system is one that produces less than about 5 g's of acceleration and less than about 5 N/cm² to the occupants or to a terrestrial-based bystander during or after the emergency landing.

### SUMMARY

Some embodiments described herein relate to an aircraft that includes a support frame, at least one gas compartment, and multiple propulsion units. The gas compartment(s) can be coupled to the support frame and configured to contain a gas having a gas density less than the density of atmospheric air surrounding the aircraft during operation. Similarly stated, the gas-filled gas compartment(s) can produce a gas lifting force on the support frame. The propulsion units can each be configured to selectively produce a propulsive force with a thrust vector with a non-zero component along a vertical axis of the support frame. The aircraft can also include an energy store operable to provide energy to the propulsion units. The aircraft can also include a payload station coupled to the support frame. The aircraft can have a maximum gross weight that includes the weight of the support frame, the gas compartment(s) the propulsion units, the energy store, the payload station, and the maximum weight of payload supported by the payload station. The maximum gross weight of the aircraft can be greater than either the gas lifting force of the maximum vertical propulsion force and less than the sum of the gas lifting force and the maximum vertical propulsion force.

### BRIEF DESCRIPTION OF THE DRAWINGS

FIGS. 1A and 1B are schematic block diagrams of an aircraft, according to an embodiment.

FIGS. 2A and 2B are front and top schematic views of an aircraft, according to an embodiment.

FIGS. 3A and 3B are front and top schematic views of an aircraft, according to an embodiment.

FIGS. 4A and 4B are top schematic views of an aircraft, according to an embodiment.

FIG. 5 is a top schematic view of an aircraft, according to an embodiment.

FIG. 6 is a top schematic view of an aircraft, according to an embodiment.

FIG. 7 is a top schematic view of an aircraft, according to an embodiment.

FIGS. 8A and 8B are front and top schematic views of an aircraft, according to an embodiment.

FIG. 9A is a perspective view of a support frame according to an embodiment, FIG. 9B is a close-up view of a joint of the support frame of FIG. 9A, and FIG. 9C is a cross section of an end portion of one of the frame members of the support frame of FIG. 9A.

FIG. 10 is a schematic illustration of a control system according to an embodiment.

FIGS. 11A to 11D are front, top, top perspective, and bottom perspective views, respectively, of an aircraft according to another embodiment.

FIG. 12 is a cross-sectional view of an aircraft according to another embodiment.

FIGS. 13A and 13B are top views of a light-sport aircraft, according to an embodiment.

FIG. 14 is a side view of the light-sport aircraft of FIGS. 13A and 13B.

### DETAILED DESCRIPTION

The disclosed aircraft, referred to herein as an Almost Lighter Than Air (“ALTA”) aircraft, has low mass, a very large cross section in the direction of gravity, produces some lift with a low density gas volume contained in one or more gas compartments or enclosures and one or more thrust rotors. In some embodiments, lift produced by the gas and/or thrust rotor(s) alone is insufficient for flight. In such an embodiment, flight achieved with the combined lift produced by the gas and multiple thrust rotor(s). Collectively, these features produce an excellent safety system in the event of a single point failure. In the event of a gas volume failure, the rotors can provide sufficient thrust for navigation to a safe location and sufficient lift to provide a safe and reasonably gentle landing. In the event of multiple rotor failures, the cross section of the aircraft in the direction of gravity along with its significant buoyancy limit the terminal velocity of the aircraft so that when combined with the non-rigid gas enclosure reduce any impulses to the occupants or bystanders to less than 5 g's and constant pressures of less than about 5 N/cm².

Some embodiments described herein relate to an aircraft that includes a support frame, at least one gas compartment, and multiple propulsion units. The gas compartment(s) can be coupled to the support frame and configured to contain a gas having a gas density less than the density of atmospheric air surrounding the aircraft during operation. Similarly stated, the gas-filled gas compartment(s) can produce a gas lifting force on the support frame. The propulsion units can each be configured to selectively produce a propulsive force with a thrust vector with a non-zero component along a vertical axis of the support frame. The aircraft can also include an energy store operable to provide energy to the propulsion units. The aircraft can also include a payload station coupled to the support frame. The aircraft can have a maximum gross weight that includes the weight of the support frame, the gas compartment(s) the propulsion units, the energy store, the payload station, and the maximum weight of payload supported by the payload station. The maximum gross weight of the aircraft can be greater than either the gas lifting force of the maximum vertical propulsion force and less than the sum of the gas lifting force and the maximum vertical propulsion force.

Some embodiments described herein relate to an aircraft having a support frame, an occupant cavity, and a gas compartment. The gas compartment can be configured to exert a buoyant force on the support frame. At least a portion of the gas compartment can be disposed below a bottom of the support frame and a bottom of the occupant cavity. In this way, the portion of the gas compartment can be compliant and the first portion of the aircraft that contacts the ground in the event of an uncontrolled or partially controlled landing.

Some embodiments described herein relate to an aircraft that includes a support frame and a gas compartment configured to exert a buoyant force on the support frame. The support frame can be constructed of multiple struts. The struts can be thin-walled cylinders (e.g., the cylinder's wall thickness can be at least an order of magnitude smaller than the cylinder's diameter). The struts can also include two end caps coupled to opposite ends. A pressurized gas can be contained within the interior volume of the struts. Such struts can be extremely light weight while possessing substantial resistance to buckling, making them particularly well suited to ALTA aircraft.

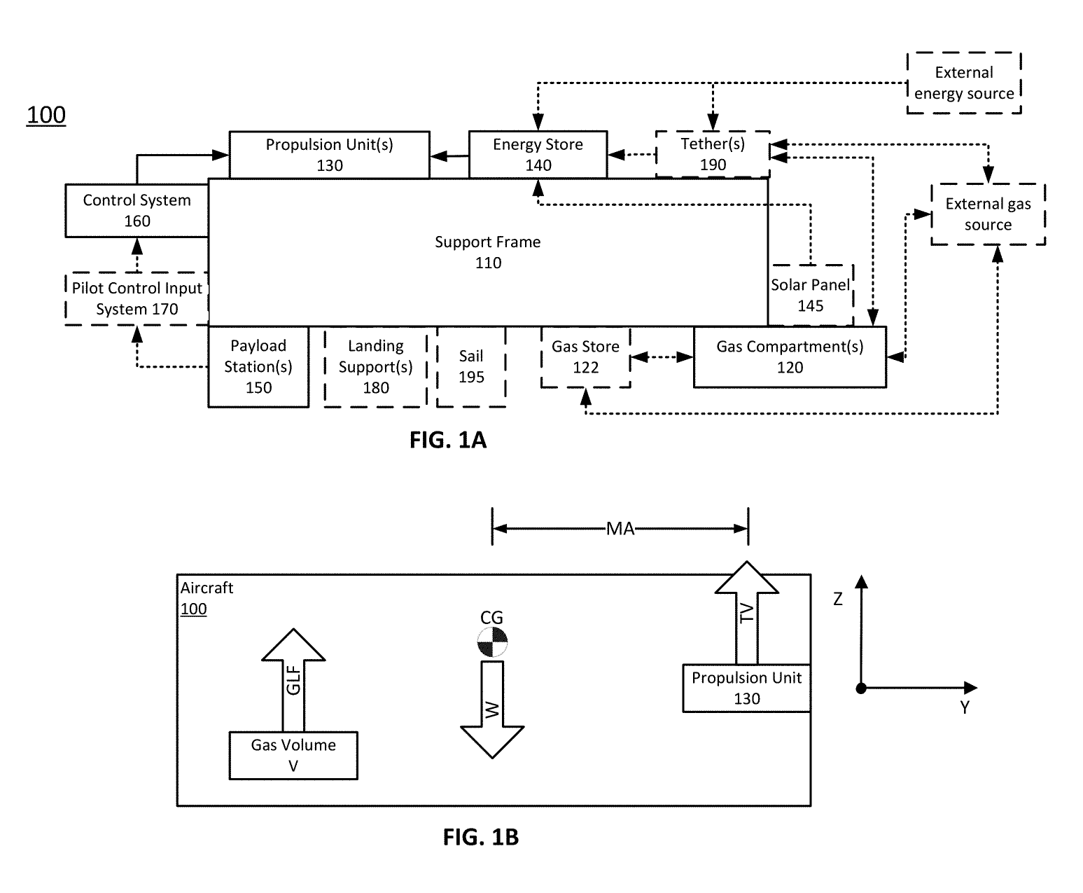

An aircraft 100 according to an embodiment is illustrated schematically in FIGS. 1A and 1B. Aircraft 100 includes a support frame 100, one or more gas compartments 120, one or more propulsion units 130, an energy store 140, a payload station 150, and a control system 160. Optionally, aircraft 100 may further include a pilot control input system 170, one or more landing supports 180, and one or more tethers 190.

Support frame 110 provides a relatively rigid structural support to which each of the other components of aircraft 100 can be coupled and that can carry the loads or forces from the propulsion units 130, aerodynamic forces, and gravity. It may be implemented in a variety of geometries and materials, as described in more detail below in connection with various embodiments. In some embodiments, the support frame is formed from elongate beams coupled to each other at their ends to form a space frame or truss, for example a tetrahedron, a square pyramid, a prism, or other suitable structure.

Aircraft 100 includes one or more gas compartments 120, which are configured to collectively contain a volume V of low density gas. “Low density” means that the gas that is less dense than the ambient atmospheric air surrounding vehicle 100. This can be achieved with a gas that has a lower atomic or molecular weight than air, such as hydrogen or helium. It can alternatively, or additionally, be achieved with a gas that is at a higher temperature than the ambient air, such a heated air, or other heated gas. The low density gas volume V provides a buoyant force, or a gas lifting force GLF, on the structure to which it is attached, i.e. support frame 110. In some embodiments, this gas lifting force GLF can provide nearly all of the lift for the aircraft, i.e. the gas lifting force GLF is close to, but less than, the total weight W of the aircraft. In other embodiments, the gas lifting force GLF can exceed the weight W of the aircraft, i.e. the aircraft can be lighter than air. In yet other embodiments, the gas lifting force GLF is much less than the weight W of the aircraft.

The gas lifting force GLF can also provide a safety mechanism in the event that other lifting forces, such as those produced by the propulsion units 130, are not available, for example due to failure of the propulsion units.

The low density gas volume V is contained within one or more gas compartments 120. Each gas compartment 120 is preferably a non-rigid or compliant structure. It is preferably formed of a material that is light but strong, to minimize the weight of the gas compartment 120. It is preferably formed of a material that is substantially impermeable to the gas to be contained, to minimize gas loss through the material. It is preferably formed of a material that is a relatively tough and durable, UV tolerant and resistant to punctures, tears, abrasions, etc. to preserve the integrity of the gas compartment 120 and avoid leaks or failure of the gas compartment 120.

Survivability of aircraft 100, for example in event of a midair collision, or other source of damage to the aircraft, can be enhanced by employing multiple gas compartments 120, so that rupture or loss of one gas compartment 120 leaves the aircraft with other gas compartments 120 that can still produce a gas lifting force GLF, though reduced.

The one or more gas compartments 120 can include an access port, valve, and/or connection by which low density gas can be introduced into and/or withdrawn from gas compartments 120. Thus, the gas compartments 120 can be filled, or refilled before flight of aircraft 100 from an external source of low density gas. Similarly, the low density gas can be partially or fully withdrawn from gas compartments 120 after flight of aircraft 100, and stored for subsequent use. In another embodiment, aircraft 100 can include an onboard store of low density gas 122, e.g. in the form of a tank of gas maintained at a higher pressure, and thus density, and the gas can be selectively introduced into, or withdrawn from, gas compartments 120, e.g. during flight to control the magnitude of the lifting force produced by the gas volume.

The lifting gas must have a density that is less than the ambient air around the structure. Heating the gases reduces the mass according to the ideal gas law, but a gas at roughly the ambient temperature is preferred leaving only helium and hydrogen. Hydrogen is diatomic and provides slightly better lift than helium, but it is explosive under many conditions leaving helium as the exemplary gas. The pressure of the lifting gas should be slightly more than the ambient atmospheric pressure so that it provides some structural support for the gas enclosures. The lifting gas does have mass so additional pressure adds weight, reducing lift. The pressure of the lifting gas at roughly the ambient temperature should be approximately 1.03 times the ambient air pressure or 1.03 atmospheres at standard pressure and temperature. In other embodiments, the pressure of the lifting gas can be equal to or less than the pressure of the ambient air pressure. In such an embodiment, the support frame 110 can maintain the structure of the aircraft.

As described in further detail herein, a portion of a gas compartment 120 can be the first structure to contact the ground in the event of an unpowered, uncontrolled, and/or partially controlled landing. The gas compartment 120 can be compliant such that it absorbs, dissipates, and/or mitigates forces and/or accelerations associated with a hard landing. In particular, compliance of the gas compartment is an inverse of the pressure of the gas contained within. In some embodiments, the gas compartment can be pressurized such that the gas compartment has a compliance of 9-9.5 or more MPa⁻¹.

Suitable materials and construction can include a polyurethane or neoprene bladder covered on the outer surface by a fabric shell such as rip stop nylon or polyester fabric, a construction often used in blimps. An exemplary laminate of a polyurethane bladder with a rip stop nylon shell weighs around 60 g/m². A construction that is lighter weight but potentially less durable is a very thin laminate of a polyester film of polyethylene terephthalate (PET, sold under the trade name MYLAR) and polyurethane, a construction used in lightweight balloons and parachutes for space probes and rovers. A suitable low weight fabric that is commercially available is Ultra High Molecular Weight Polyethylene fiber monofilaments and polyester films (such as those sold under the trade names CUBEN or DYNEEMA). The fabric can be sealed with silicone to produce a material that can be as light as 17.3 g/m². Other suitable strong, lightweight fabrics have been developed for applications in the camping, rock-climbing, defense, and sailing industries.

As noted above, the one or more gas compartments 120 are preferably compliant. For example, a gas compartment formed of a laminate fabric material such as those described above, and pressurized with the low density gas (i.e. filled to a pressure above that of the ambient atmosphere) is compliant, like a balloon. A significant benefit of this structure is that it provides a significant cushion for impacts, such as an undesired impact with the ground following a failure of one or more of the propulsion units. This cushioning effect can protect the occupant(s) of the aircraft by reducing the deceleration forces experienced upon impact. It can also protect bystanders who may be impacted by the aircraft, by reducing the pressure load on the bystander below a survivability threshold.

The one or more gas compartments 120 are coupled to the support frame 110 to transmit the gas lifting force to the aircraft. Each gas compartment 120 may be attached to the support frame outside of the space bounded by the support frame 110, or may be contained within the space bounded by the support frame 110, or may be partially within and partially without. Each gas compartment may also enclose a part of the support frame 110, i.e. a member of a support frame 110 may pass through the gas compartment 120. In such an embodiment, the intersection of the member of the support frame 110 and the wall of the gas compartment 120 should be sealed, i.e. prevent gas leakage, using any suitable technique known in the art. In some embodiments, the support frame 110 is contained entirely within the one or more gas compartments 120, which provides the minimum impulse forces to bystanders in the event of an unpowered landing or impact with the ground or fixed structure.

At least a portion of the exterior surface(s) of the one or more gas compartments 120 may form a portion of the skin or wetted surface of the aircraft, i.e., be exposed to the atmosphere. In some embodiments, the collective portions of the exterior surface(s) of the one or more gas compartments 120 that are exposed to the atmosphere may define the majority of the wetted surface of the aircraft. In some embodiments, the one or more gas compartments 120 may be covered by or enclosed within an outer skin of the aircraft (not shown). Such an outer skin may enclose multiple gas compartments as well as the support frame 110 to produce an aerodynamically efficient profile for the aircraft 100.

Collectively, the one or more gas compartments 120, optionally enclosed by an outer skin, which may also enclose some or all of any portion of the support frame 110 not contained within the gas compartments 120, define the overall shape of the aircraft 100. The shape of the gas compartments 120 is largely maintained by segmenting the gas compartments in conjunction with the shape of the support frame. The gas volume V must be large relative to the overall size and volume of the aircraft 100 to provide a meaningful gas lift force GLF relative to the weight W of the aircraft 100. The gas compartments 120 are preferably shaped with a relatively small cross-section in the Y-Z plane to minimize air resistance, e.g. form drag, for motion in the horizontal, X axis, direction and correspondingly to minimize drift in the lateral, Y axis, direction due to cross winds.

Correspondingly, the gas compartments 120 are preferably also shaped to provide a relatively large cross-section in the X-Y plane to maximize air resistance for motion in the vertical, Z axis, direction. Although this reduces the available rate of climb than can be produced by the propulsion units 130 when it is desired to gain altitude, it also reduces the terminal velocity in the negative Z direction, i.e., in the direction of gravity, during an uncontrolled descent, such as following a failure of one or more of the propulsion units 130 and/or a reduction or loss of gas lifting force GLF due to a leak or rupture of one or more of the gas compartments 120. In some embodiments, the ratio of the cross sections in the vertical versus the horizontal directions is greater than 3 to 1, which can provide a suitable terminal velocity in the vertical direction and air resistance drag in the horizontal.

As noted above, the gas compartments 120 also provide a significant cushion for impacts. The combination of limited terminal velocity and the cushioning effect reduce the deceleration of the aircraft upon impact with the ground or a fixed structure during an unpowered landing, minimizing damage to the aircraft 100 or injury to the occupants (pilot and/or passengers) or bystanders. In particular, in some embodiments, a gas compartment 120 can be the lowermost structure of aircraft. Similarly stated, the gas compartment 120 can be disposed below a bottom of the support frame 110, propulsion units 130 and/or payload station 150. In this way, the gas compartment 120 can be the first portion of the aircraft 100 to contact the ground in the event of an uncontrolled or partially controlled landing. As described in further detail herein, gas within the gas compartment can have a relatively low pressure such that the gas compartment is relatively compliant (an inverse of pressure) and deforms in the event of contact with terrestrial property or bystanders.

The shape of aircraft 100 may be generally omnidirectional in the horizontal, X-Y, plane, with a low aspect ratio (the ratio of the width along the longitudinal, or Y axis, direction to the length along the longitudinal, or X axis, direction) and a relatively small cross section in the Y-Z plane. In this way, the aircraft 100 can be configured for omnidirectional travel in the horizontal plane. The usual desire of pilots to move many times farther horizontally than vertically is also reflected by the relatively large cross-section in the X-Y plane and much smaller relative cross-sections in the Y-Z and X-Z planes, as this configuration typically reduces the energy (integral of drag and distance traveled) required to overcome air resistance during a flight.

Preferably, during flight the aircraft maintains a generally horizontal, flat attitude, i.e., it is neither pitched up nor pitched down, and thus presents the minimal Y-Z cross-sectional area to the relative wind generated during forward motion, and therefore relatively low air resistance or drag. Since the upward (positive Z axis) forces required to oppose or overcome the weight W of the aircraft 100 can be provided by the gas lifting force GLF and the positive Z axis component of the thrust vector of each of the one or more propulsion units 130, it is not necessary to pitch up the aircraft 100 to generate any aerodynamic lift forces. Thus, the aircraft 100 can maintain the minimal Y-Z cross-sectional area.

However, in some embodiments and/or in some modes of operation, the aircraft 100 can be pitched up to generate some aerodynamic lift and incur a performance penalty in induced drag and increased form drag. In some embodiments, the cross section of the aircraft 100 in the X-Z plane can have a longer path length across the top surface of the aircraft than across the bottom surface of the aircraft. This geometry enables the body of the aircraft 100 to function as a lifting body, i.e. to produce additional lift during forward, horizontal motion in the X direction. This aerodynamic lift produces a corresponding induced drag, and the aircraft 100 can be pitched up to generate more lift but correspondingly more induced drag.

In a conventional multi copter (e.g. quadcopter or hexacopter) configuration the direction of the thrust vectors of propulsion units are fixed, and it is necessary to pitch the aircraft down to tilt the thrust vectors of the propulsion units forward to produce a component of thrust in the positive X direction for forward movement. However, in some embodiments of aircraft 100, the one or more propulsion units 130 are configured to change the direction of their thrust vectors TV relative to the aircraft 100, and thus can produce a positive X axis component of thrust. This enables forward propulsion without tilting the body of the aircraft relative to the horizontal.

In some embodiments, and/or in some modes of operation, the aircraft 100 can be pitched down as an additional or alternative, method of tilting forward the direction of the thrust vectors TV of the propulsion units 130.

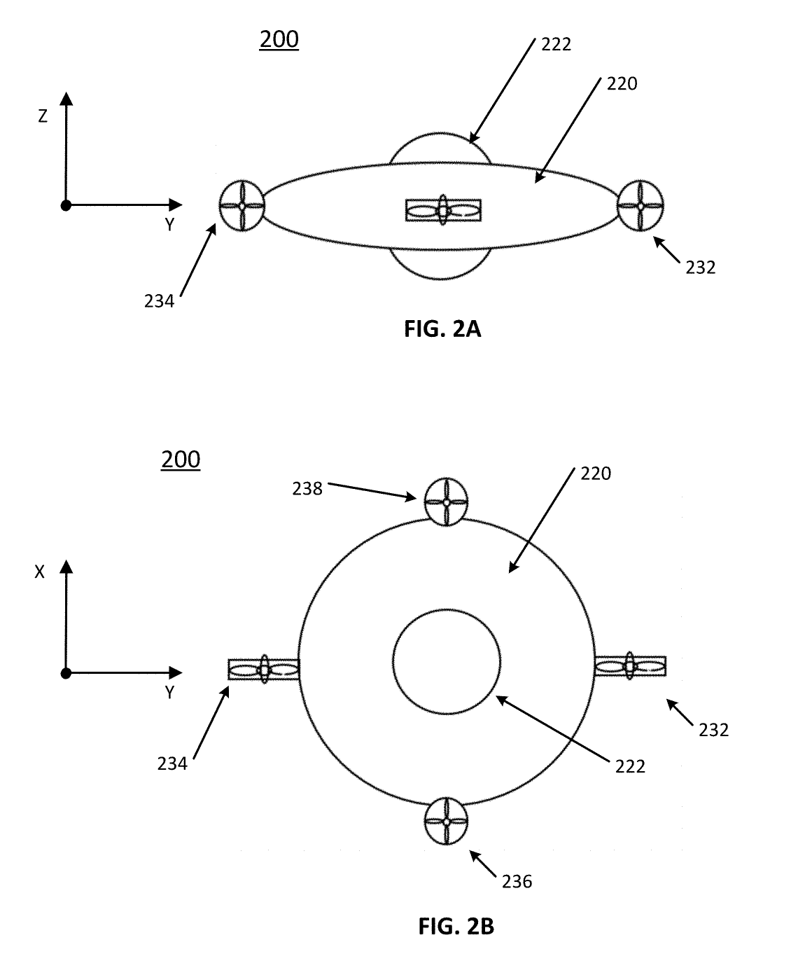

The considerations described above for the shape of the aircraft 100 and thus the configuration and arrangement of the one or more gas compartments 120 can be met by a geometry of the aircraft 100 that is similar to traditional depictions of a “flying saucer,” i.e. an annulus with a spherical bulb in the center. Aircraft 200, shown in FIGS. 2A and 2B, shows such a geometry. Aircraft 200 includes an annular or toroidal shaped gas compartment 220, and a spherical gas compartment 222 disposed in the center of gas compartment 220. Aircraft 200 has a relatively small cross sectional area in the Y-Z plane, as shown in FIG. 2A, and a relatively large cross-sectional area in the X-Y plane, as shown in FIG. 2B. Aircraft 200 also has a low aspect ratio, approximately 1:1, as it is approximately circular in top view, as shown in FIG. 2B. Aircraft 200 includes four propulsion units 232, 234, 236, and 238, distributed about the periphery of the aircraft. The other components of aircraft 200 are not shown, for simplicity of illustration.

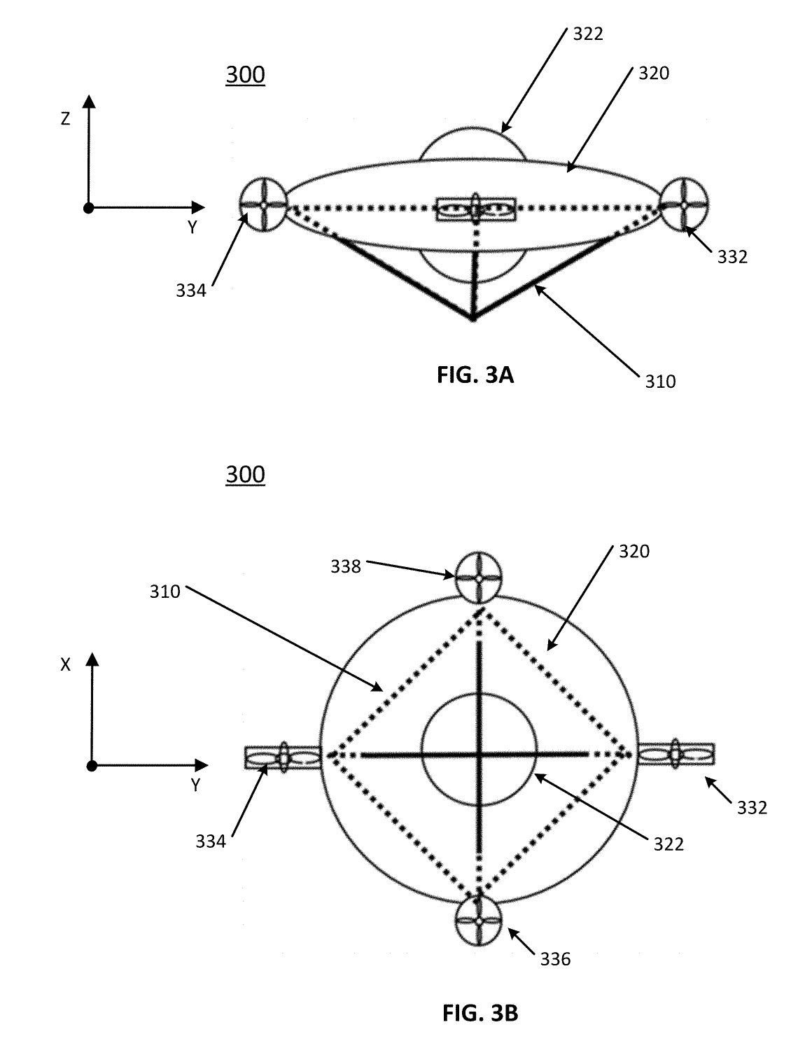

In another embodiment, shown in FIGS. 3A and 3B, aircraft 300 also includes an annular or toroidal shaped gas compartment 320, and a spherical gas compartment 322 disposed in the center of gas compartment 320. Aircraft 300 also has a relatively small cross sectional area in the Y-Z plane, as shown in FIG. 3A, and a relatively large cross-sectional area in the X-Y plane, as shown in FIG. 3B. Aircraft 300 also has a low aspect ratio, approximately 1:1, as it is approximately circular in top view, as shown in FIG. 3B. Aircraft 300 includes four propulsion units 332, 334, 336, and 338, distributed about the periphery of the aircraft. Aircraft 300 includes a support frame 310, which in this embodiment is a pyramidal frame formed of linear struts coupled together at the lower apex and the outer corners of the frame 310. In this embodiment the support frame 310 passes through, and is partially contained within, gas compartments 320, 322. In this embodiment, the support frame's apex is below the gas compartments 320, 322. This arrangement yields a relatively lower location for the center of gravity, CG (not shown), of aircraft 300, enhancing stability in pitch and roll of aircraft 300. In other embodiments, the apex can be above the gas compartments 320, 322 such that the gas compartment 322 can be the lowermost structure of the aircraft 300.

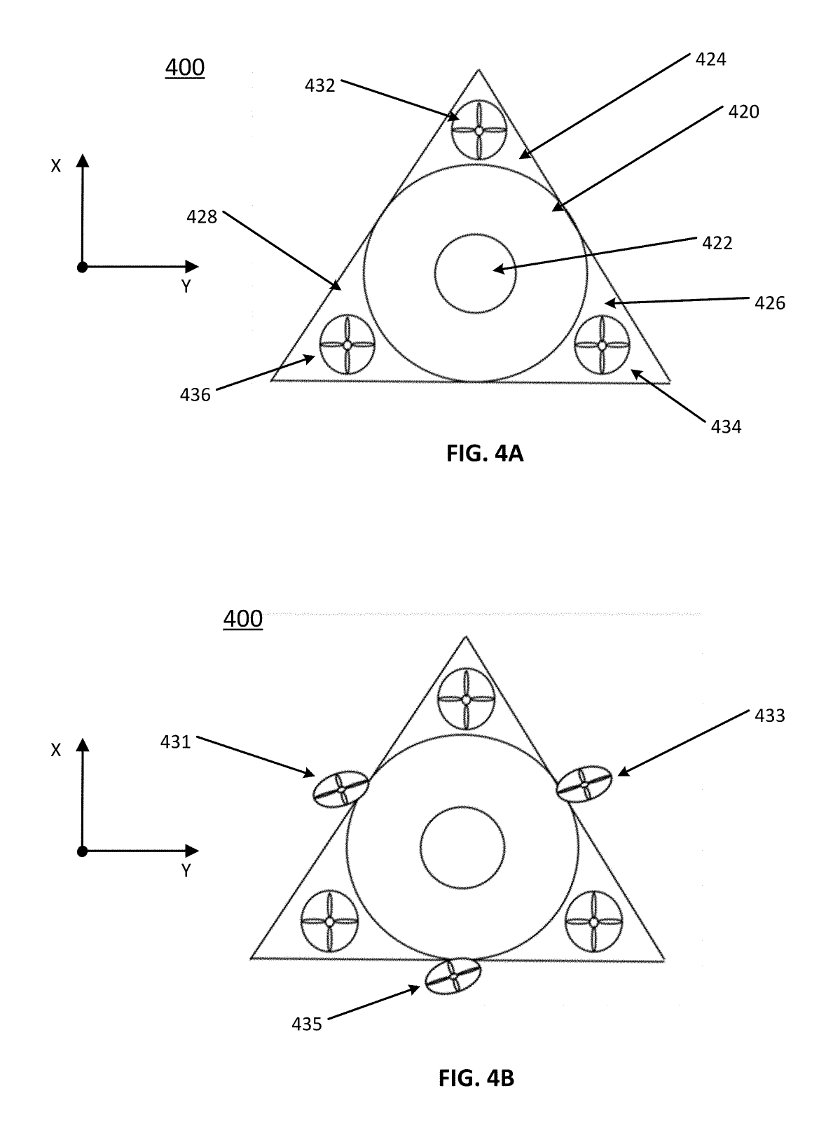

Additional structure and gas compartments can extend from the periphery of the main annular shape to define symmetric, geometric corners. These corners can house the propulsion units in the fashion of a multiple rotor copter drone. This arrangement is shown in FIGS. 4A and 4B, for aircraft 400. In this embodiment, aircraft 400 has a triangular planform, with one apex of the triangle oriented in the intended direction of forward flight, i.e. in the positive X axis direction. As with the previous embodiments, aircraft 400 includes an annular or toroidal gas compartment 420, and a spherical gas compartment 422 disposed in the center of gas compartment 420. In addition, roughly triangular gas compartments 424, 426, and 428 are disposed around the periphery of gas compartment 420. Each of these additional gas compartments has disposed therein or therethrough a propulsion unit, 432, 434, and 436, respectively. As shown in FIG. 4B, aircraft 400 may have additional propulsion units 431, 433, 435, also on the periphery of the aircraft, but not embedded in gas compartments.

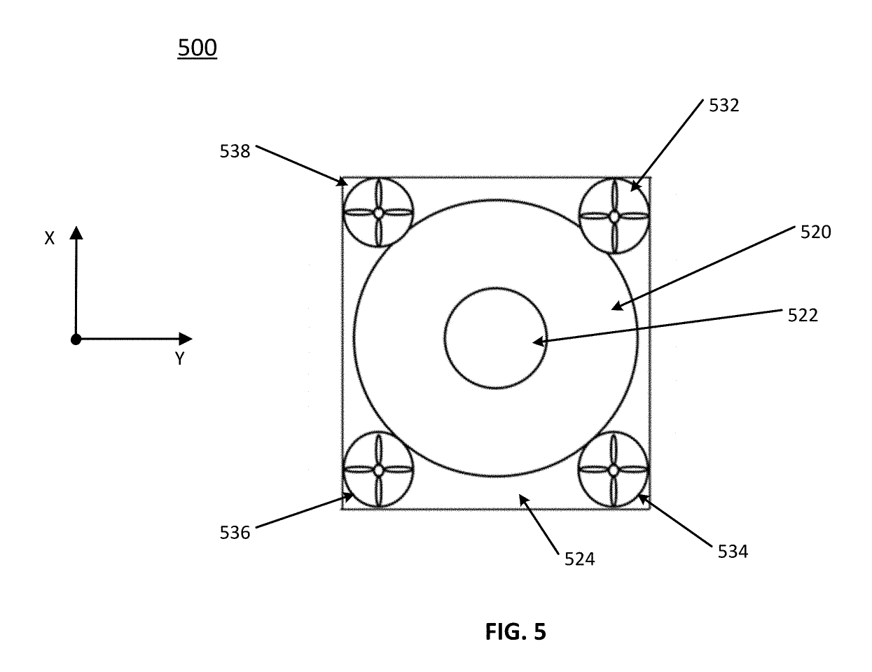

Other geometries for the overall shape of aircraft 100. For example, as shown in FIG. 5, aircraft 500 has an approximately square planform. As with the previous embodiments, aircraft 500 includes an annular or toroidal gas compartment 520, and a spherical gas compartment 522 disposed in the center of gas compartment 520. In addition, one or more additional gas compartments 524 are disposed around the periphery of gas compartment 520. The additional gas compartment(s) has disposed therein or therethrough propulsion units 532, 534, 536, and 538.

The aircraft consists of a gas enclosure that has a smaller cross section in profile than in projection. This follows the functions of least air resistance for lateral movement and cross winds while maximizing air resistance vertically for safety in the event of a power failure. The gas enclosures should include central, approximately spherical sections for payload, pilot and passengers and/or additional gas enclosures.

The one or more propulsion units 130 can each provide a propulsive force or thrust, which can be considered as a thrust vector having a magnitude of a propulsive force and a direction in the frame of reference of the aircraft. The aircraft frame of reference can be defined in a convention orthogonal axis system with an X axis along the longitudinal axis of the aircraft (along with the aircraft generally travels and about which the aircraft rolls), a Y axis along the lateral axis (about which the aircraft pitches) and a Z axis (along with the aircraft changes altitude and about which the aircraft yaws).

Preferably, each of the one or more propulsion units 130 can selectively generate a variable propulsive force from zero to a maximum propulsive force. Each of the one or more propulsion units 130 may have a thrust vector with a fixed direction or with a reversible direction (i.e. a positive or negative propulsive force in a fixed direction), or may be capable of changing the direction of the thrust vector about one, two, or all three of the aircraft axes.

Each of the one or more propulsion units 130 can have a thrust vector TV with a non-zero component along the longitudinal or X axis, to propel the aircraft along a course or flight path over the surface below the aircraft. Alternatively, or additionally, each of the one or more propulsion units 130 can have a thrust vector TV with a non-zero component along the vertical or Z axis, to increase or decrease the altitude of the aircraft. In some embodiments, the collective maximum propulsive force of the one or more propulsion units in the positive Z axis direction (up) can provide nearly all of the lift for the aircraft, i.e., the maximum vertical propulsion force is close to, but less than, the total weight of the aircraft. In other embodiments, the maximum vertical propulsion force can exceed the weight of the aircraft, i.e., the aircraft can lift off from the surface vertically, or otherwise increase altitude, without any gas lifting force. In some such embodiments, the aircraft can have a nominal or cruise maximum vertical propulsion force, beyond which power consumption increases significantly. The nominal maximum vertical propulsion force may be less than the total weight of the aircraft, however, it may be possible to exceed the nominal maximum vertical propulsion force such that the aircraft can increase in altitude without any gas lifting force. For example, below the nominal maximum vertical propulsion force, each unit of force delivered by the propulsion units consumes 0.1 or fewer units of energy from the energy store 140, while above the nominal maximum vertical propulsion force, each unit of power delivered by the propulsion unit consumes 0.5 or more units of energy from the energy store. In yet other embodiments, the maximum potential vertical propulsion force is much greater than the weight of the aircraft.

In some embodiments, each of the propulsion units 130 can include a rotor, similar to a conventional propeller. In such embodiments, the propulsion units may also be able to change the direction of the thrust vector produced by the rotor by changing the orientation of the rotor with respect to the body of aircraft 100 about one or two axes. For example, the rotor can be mounted in a gimbal arrangement with two nested rings that pivot orthogonally to each other. The orientation can be changed by an electromagnetic or other types of motor or engine to change the angle of each of the rings about their respective pivot axes. In some embodiments, the rings can be augmented, e.g. partially or completely enclosed, with cages that allow air to pass through the rotor disc but prevent larger objects, including flying animals such as birds and bats. The cages can be attached to the rings or the body of the aircraft. In some embodiments, the rotors are open, and in other embodiments they may be ducted.

As shown schematically in FIG. 1B, the aircraft 100 has a center of gravity GC. The location of the CG can vary depending on the location and weight of variable components such as the payload, including pilot and/or passengers. It can also vary during operation, e.g. by depletion of energy in the energy store 140 (e.g. chemical fuel). Each of the one or more propulsion units 130 can be disposed at the same vertical location as the CG, or can be vertically spaced apart from the CG. Each of the one or more propulsion units 130 can have a thrust vector TV with a direction (whether fixed or variable) that passes through the CG. In this case, the propulsion force tends to propel the aircraft along the thrust axis of the propulsion unit 130 but not to change the attitude of the aircraft, i.e. not to pitch, roll, or yaw the aircraft. Alternatively, each of the one or more propulsion units 130 can have a thrust vector TV with a direction (whether fixed or variable) that is offset from the CG. In this case, the propulsion force tends to change the attitude of the aircraft, i.e. to pitch, roll, or yaw the aircraft.

The control authority over the attitude of the aircraft by each propulsion unit 130 depends on the magnitude of the force and the moment arm MA between the thrust vector TV and the CG. Thus, the further each propulsion unit is spaced from the CG in a direction perpendicular to the thrust vector, the greater the moment arm and the control authority. In some embodiments, each propulsion unit is disposed at the periphery or an extremity or edge of the aircraft. This can provide maximum spacing, and thus moment arm MA, for the propulsion unit(s) 130 to provide attitude control over the aircraft. For example, as shown schematically in FIG. 1B, propulsion unit 130 is at the edge of the aircraft 100, maximizing the moment arm MA from the center of gravity CG. The thrust vector TV, which is oriented along the vertical, or Z axis, thus produces a rolling moment about the CG, i.e., about the longitudinal or X axis, the magnitude of which is equal to the magnitude of the thrust vector TV multiplied by the moment arm MA.

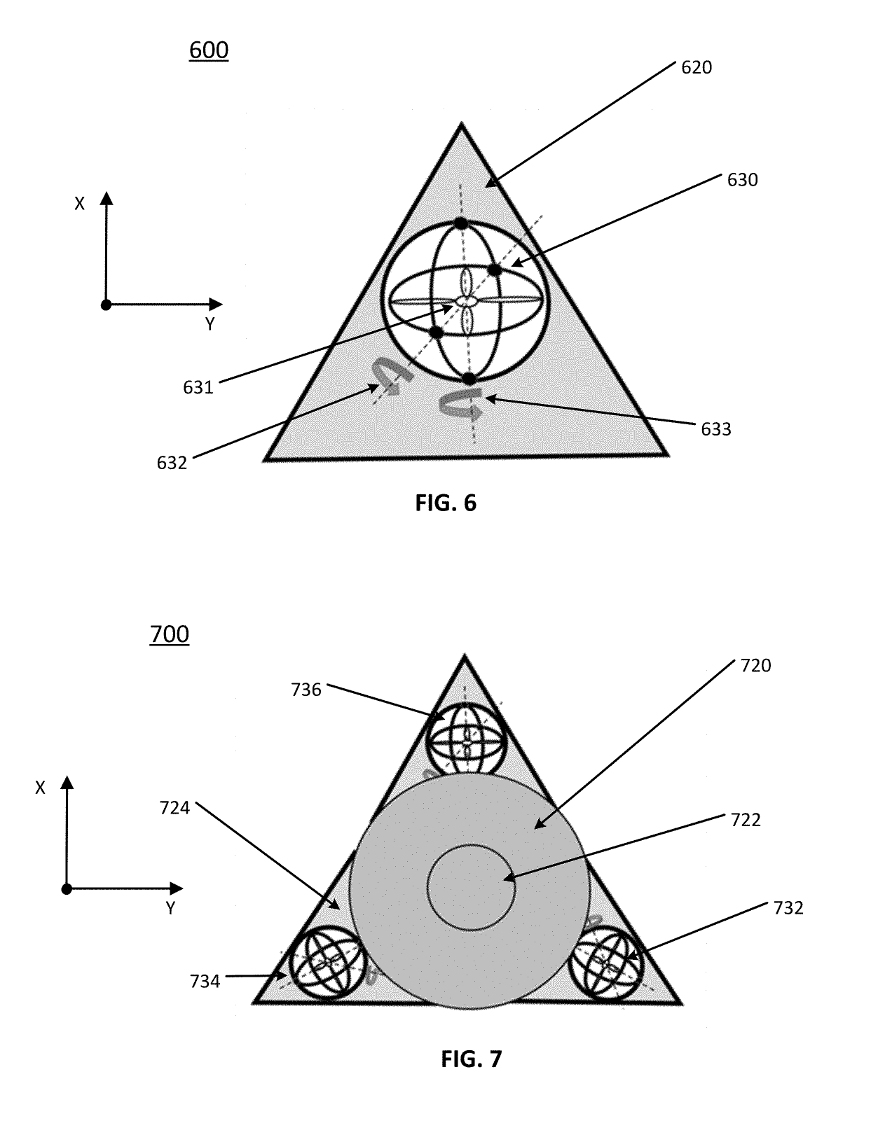

Aircraft 600, illustrated schematically in FIG. 6, has an approximately triangular planform, with one or gas compartments 620. Aircraft 600 includes a single propulsion unit 630, mounted in the center of gas compartment(s) 620. As shown, propulsion unit 630 is includes a rotor 631, mounted in a gimbal arrangement by which the direction of the thrust vector TV of rotor 631 can changed about two orthogonal pivot axes, 632, 633.

In another embodiment, illustrated schematically in FIG. 7, aircraft 700 also has an approximately triangular planform, with an annular gas compartment 720, a central gas compartment 722, and one or more additional gas compartments 724 are disposed around the periphery of gas compartment 724 to define the triangular planform of the aircraft 700. The additional gas compartment(s) has disposed therein or therethrough propulsion units 732, 734, and 736, each of which includes a gimbal arrangement similar to that of aircraft 600.

The shape of the aircraft 100 and the ability to change the direction of the thrust vector TV of the one or more propulsion units 130 are interrelated, and differentiate from previous approaches to LTAs. For example, traditional zeppelins or blimps typically feature a large gas body with a few rotors affixed externally. Generally, these rotors are fixed with respect to the gas body with internal bladders and ailerons providing pitch and roll control and rudders providing yaw controls, similar to the controls of a HTA aircraft. The rotors may be rotated with respect to the gas body, however rotations of the rotors relative to the gas body are only useful for orientations that are primarily perpendicular to the gas body. This is a result of the gas body having to be many times larger than the rotor with the gas body preventing significant airflow in the direction of the rotor mounts. The relatively low profile in the horizontal cross section of the aircraft 100 allows the rotors to be fully gimbaled and still provide useful thrust in any orientation.

The energy store 140 can be any suitable storage device, or collection of devices, that can receive, store, and provide to the one or more propulsion units 130 energy in the form required by the propulsion unit(s). For example, if the propulsion units 130 include electric motors, then the energy store 140 can be any one or more devices that can store electrical energy to provide to the propulsion unit(s). In this example, energy store 140 can be in the form of one or more batteries, e.g. electrochemical batteries, either primary or, preferably, secondary, or fuel cells. Energy store 140 could also be implemented as one or more capacitors or other charge storage devices. Energy store 140 could also be implemented as an electromechanical or kinetic energy storage device, such as a flywheel-based motor/generator. Alternatively, if the one or more propulsion units 130 include combustion-based engines, such as an internal combustion engine, the energy store can be one or tanks for storage of chemical fuel such as gasoline, diesel, natural gas, hydrogen, etc., whether in gaseous, liquid, or solid form.

In some embodiments, energy store 140 is disposed relatively low within or on the aircraft 100, to move the CG of the aircraft relatively lower to enhance stability, which can reduce unwanted pitch and roll. If multiple energy stores 140 are used, they are preferably distributed relatively evenly about the CG of aircraft 100.

Energy store 140 is coupled to the one or more propulsion units 130 to provide the required energy, such as by conductive cables (for electrical energy), fluid lines (for chemical fuel in gas or liquid form), etc. Energy store 140 may also be coupled or allowed to be selectively coupled to an external source of the stored energy format, such as an external source of electrical charge, chemical fuel, etc. so that the energy store 140 can be filled before flight of the aircraft 100 (e.g. from an external chemical fuel supply, electrical power source, etc.) or refilled during flight (e.g. by a separate refueling aircraft such as a fuel tanker).

In other embodiments, energy store 140 can be coupled to an onboard source of energy, such as one or more photovoltaic solar panels 145 carried on the aircraft 100. The solar panels 145 may be mounted on the exterior of the one or more gas compartments 120 or optional external skin. Alternatively, the one or more gas compartments 130 may be optically transparent and the solar panels 145 may be disposed within the gas compartments 130.

The aircraft 100 includes one or more payload stations 150. The payload stations 150 can provide a secure support for inanimate payload, such as cargo, animate payload such as passengers, and/or a human pilot. For animate payload, e.g. passengers or pilot, the payload stations 150 can include appropriate environmental support, such as climate control (heat, air conditioning), an oxygen supply, and protection from wind and weather (a windscreen or completely enclosed station). Each of the one or more payload stations 150 may be enclosed within the, or one of the, gas compartment(s) 120.

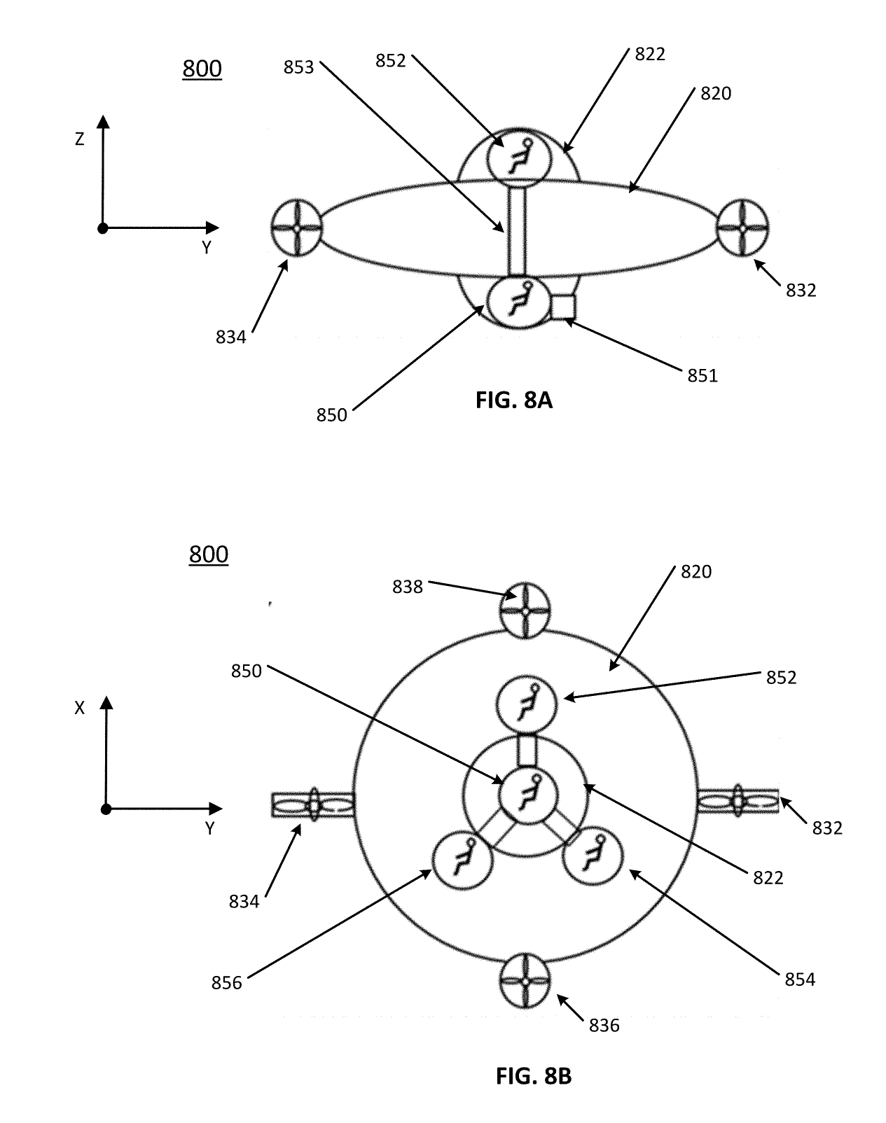

Exemplary arrangements of payload stations are shown in FIGS. 8A and 8B. Similar to aircraft 200 and 300 described above, aircraft 800 includes an annular or toroidal gas compartment 820, and a central gas compartment 822 disposed in the center of gas compartment 820. Aircraft 800 includes four propulsion units 832, 834, 836, and 838, distributed about the periphery of the aircraft. As shown in FIG. 8A, payload stations 850, 852 are disposed within central gas compartment 822. In the illustrated embodiment, payload stations 850, 852 are able to accommodate passengers, one of which may be a pilot. Payload station 850 can be accessed by an access port 851. Payload stations 850 and 852 are connected by an access passageway 853, so that a passenger or pilot can access payload stations 852 via access port 851, payload station 850, and access passageway 853. Each payload station in which a passenger or pilot may be disposed may include a seat and/or harness that coupled to the support frame (not shown). In the illustrated embodiment, the payload stations 850, 852 extend beyond the toroidal gas compartment 820 to enhance visibility above and/or below aircraft 800. The aircraft 800 may include any configuration or arrangement of payload stations the pilot and passengers. For example, as shown in FIG. 8B, four payload stations 850, 852, 854, and 856 may be arranged in a hub and spoke arrangement.

The aircraft includes a control system 160. Control system 160 can provide control inputs to the one or more propulsion units 130 to selective vary the thrust vector (magnitude and/or direction) of each propulsion unit, thus controlling movement of the aircraft 100. Control system 160 can control other aspects of operation of aircraft 100, such as conditions in the one or more payload stations 150, communications equipment. Control system 160 can receive inputs from various sources to affect its operation, including, as discussed below, an optional pilot control input system 170, as well as communications equipment, navigation equipment (such as GPS, compasses, VORs, or other aviation navigation system), inertial measurement equipment (e.g. accelerometer-based inertial measurement equipment), etc. Thus, aircraft 100 can be controlled by a pilot, by an onboard automated system, or remotely.

The aircraft 100 may optionally include a pilot control input system 170. In some embodiments, the pilot control input system 170 can include conventional aircraft control devices such as a yoke, rudder pedals, trim setting devices, and other devices that can be used by a pilot to control the flight path and attitude of an aircraft. In other embodiments, the pilot control system 170 can include automotive-style control devices, such as a steering wheel, accelerator pedal, brake, etc. Optionally, a steering wheel can telescope to provide attitude control. In some such embodiments, control system 160 can include software (stored in memory and/or executing on a processor) operable to translate automotive controls to aerodynamic inputs. For example, a “brake” input can cause one or more propulsion units to direct their thrust vectors towards the front of the aircraft, slowing and/or reversing travel in the forward direction. In addition or alternatively, the control system 160 can include a dual-stick controller similar to those used to remotely operate aircraft. The pilots control inputs to pilot control input system 170 can thus be conveyed as inputs (whether electrical, optical, hydraulic, mechanical, etc.) to control system 160. In another embodiment, the pilot control input system can be integrated into the seat for the pilot, so that the pilot's movement, including rotation, pitch, and tilt of the pilot's seat, can generate the control inputs.

The aircraft 100 may optionally include one or more mechanisms for supporting or coupling the aircraft 100 to a fixed structure such a building or mast, or directly to the ground. For example, the aircraft 100 may include one or more landing supports 180. Landing supports 180 may be coupled to the support frame 110 and have one or more portions for contact the ground of fixed structure, and be configured to support the weight of aircraft 100, with or without the benefit of any lifting forces from the gas volume or the propulsion units 130. For example, the landing supports 180 may be similar to conventional aircraft landing gear, with wheels, or may be implemented as more simple struts that do not include wheels. The landing supports may be retractable into the aircraft 100, or may be fixed. In some embodiments, the landing supports 180 may remain retracted during an uncontrolled or partially controlled landing such that a gas compartment 120 is the first structure to contact the ground.

The number of landing supports 180 may be equal the number of propulsion units 130, or may be specialized and not associated with the propulsion units 130. One or more of the landing supports may also be associated with the one or more payload stations 150, and may be, or include, a ladder for entering or exiting the aircraft or payload station 150.

In addition to, or alternatively to, the landing supports 180, the aircraft 100 may include one or more tethers 190. The tethers 190 can enable the aircraft 100 to be selectively coupled to the ground or a fixed structure. In contrast to landing supports 180, tethers 190 may be tension members that resist lifting forces supplied by the gas volume and/or the propulsion units 130, rather than compression members that resist all or a portion of the weight of aircraft 100.

In some embodiments, the tether(s) 190 can include conductive cables or fluid conduits by which energy can be supplied to the energy store 140, providing for refilling the energy store 140 and/or powering the propulsion units 130, while the aircraft 100 is tethered. In some embodiments, the tethers 190 can include conduits by which low density gas can be supplied to, or removed from, the one or more gas compartments 120.

In some embodiments, the energy store 140 can be coupled with a release fixture to the support frame 110, and coupled to the tether(s) 190, so that the energy store 140 can be used as an anchor for the aircraft 100. In other words, the energy store can be decoupled from the support frame 100 and disposed on the ground or a fixed structure, and provided that the gas lifting force GLF is less than the weight W of the aircraft 100 including the weight of the energy store 140, the aircraft 100 will be moored to the ground of fixed structure by energy store 140. Before flight of the aircraft 100, the energy store 140 can be raise to the aircraft 100 and coupled to the support frame 110.

In some embodiments, aircraft 100 may include an orientation wing element(s), sail(s) or drogue(s) 195 that may be deployed in the event of a rotor power loss. The wing element(s), sail(s) or drogue(s) 195 can provides drag in the direction of gravity that is greater than the force required to flip the aircraft.

As discussed above, the support frame 110 of aircraft 100 serves several functions, including distributing the forces produced by the propulsion units and the gas lift force of the gas compartments, and maintaining the shape of aircraft 100 in the event of pressure loss in the gas compartments. The support frame must therefore have sufficient strength to carry the forces of the propulsion units and gas compartments and the weight of the aircraft. For many embodiments, the peak forces for operation are relatively low compared to the distances spanned, e.g. <100 N/m. In this range of force/m, the thickness of the materials in the struts that form the support frame, e.g., a pyramidal support frame, become so small that it becomes difficult to make the struts rigid.

For many embodiments of aircraft 100, the relatively low forces that must be carried by support frame 110, and the desire for very low weights suggests that the cylinder wall of the struts from which the support frame is formed be very thin. Thin walls are more sensitive to material flaws and flaws lead to buckling failure. A structural strut that is secured at both ends can sustain what is known as Euler's formula for critical force before buckling. It is buckling that is the failure mode and buckling is dependent on three primary factors: a) the end mounting conditions (i.e. fixed or hinged as well as the distribution of the force at the ends), b) the modulus of elasticity of the material; and c) the area moment of inertia of the strut. Somewhat surprisingly, the compressive strength of the material is not as important as these other factors.

Traditional methods for evaluating buckling use the material's specific stiffness relating to Euler buckling:

$${F}_{Euler} = \frac{{π}^{2} EI}{{( KL )}^{2}}$$

where F_{Euler} is the maximum force, E is the modulus of elasticity, I is the area moment of inertia, L is the strut length, and K is the effective strut length factor which is a function of the end mounting conditions and varies from 0.5 to 2. A support strut for which weight is a critical consideration requires a figure of merit that relates Euler's critical force with the mass of the strut. A relevant figure of merit is F_{Euler}/(mass/length). The natural shape of an ultra-lightweight support strut is a thin cylinder. This is a result of the highest possible moment of inertia per unit mass. For a thin cylinder

I=πr³t

where I is the moment of inertia, r is the radius of the cylinder, and t is the thickness of the wall. In some embodiments described below, the figure of merit for the support strut is more than ten times that of a strut formed of steel or aluminum.

The ultra-lightweight support frame is formed of struts that have a thin cylinder that features a very high modulus of elasticity and low density per unit length, a membrane that is impermeable to gas, and end caps that distribute the axial force to the ends of the thin cylinder while providing some radial support.

The ultra-lightweight frame involves three primary characteristics. First, a very thin (e.g., a cylinder having a wall thickness that is one or more orders of magnitude smaller than the diameter), very strong cylinder, preferably made of carbon fiber, in which the shape of the cylinder is maintained by gas pressure. Similarly stated, the cylinder can be filled with air (optionally dry air), nitrogen, helium, hydrogen, etc. In some embodiments, the cylinder can be filled with a high-molecular weight gas reducing or eliminating the need to refill the cylinder. As an example, the cylinder can be pressurized to approximately 15 atmospheres. In some embodiments, the gas pressure is maintained by an internal membrane. In other embodiments, the cylinder walls themselves can maintain the gas pressure. The internal pressure induces longitudinal stresses in the cylinder, counteracting compressive forces that would tend to induce buckling. Such pressurized cylinders can be particularly resistant to buckling. U.S. Pat. No. 5,555,678, the disclosure of which is hereby incorporated by reference in its entirety, describes further details of a pressurized tubular member's resistance to buckling.

Second, the buckling forces are minimized by an end cap that provides relatively uniform force over the end of the thin cylinder which has relatively large diameter along with some internal and external support for a short distance over the thin cylinder.

Third, the mating of strut elements and the structural configuration couple to maintain only axial forces to the strut elements. This is accomplished by providing as close to single point mating between the strut elements. This is enabled by two design features: the strut elements are configured so that the single point mates are axial to each of the strut elements and the end caps are tapered so that the thin cylinders can have a large diameter and can still mate at nearly a single point.

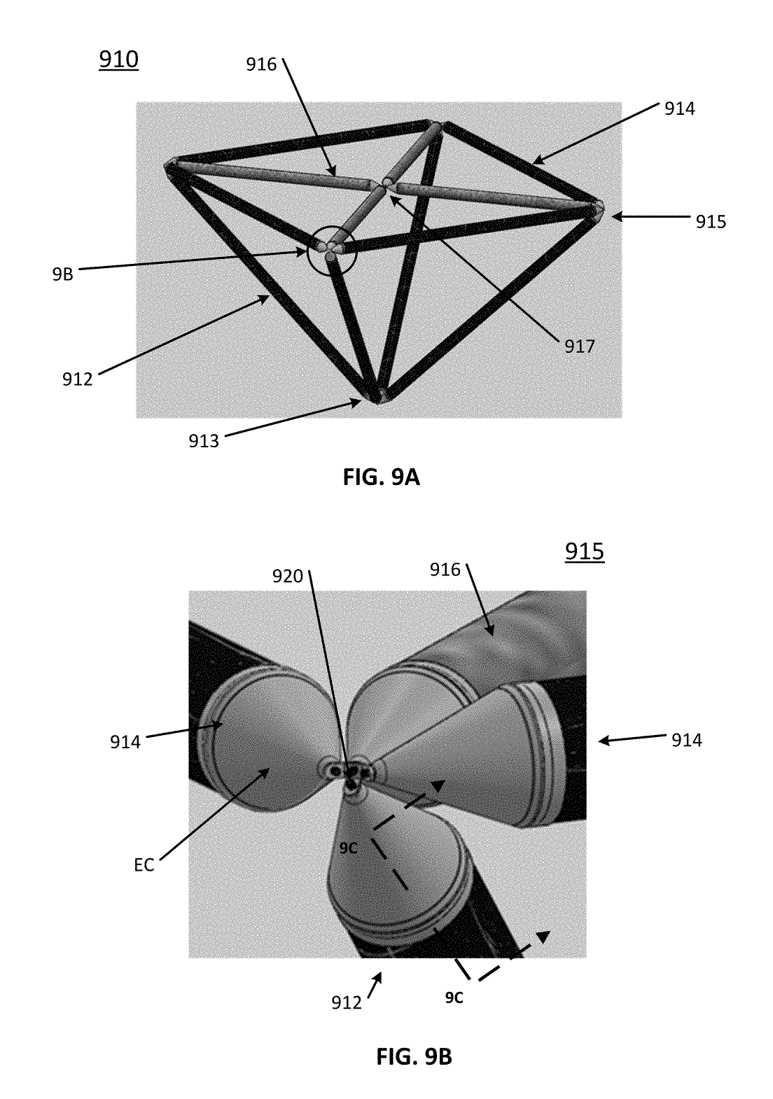

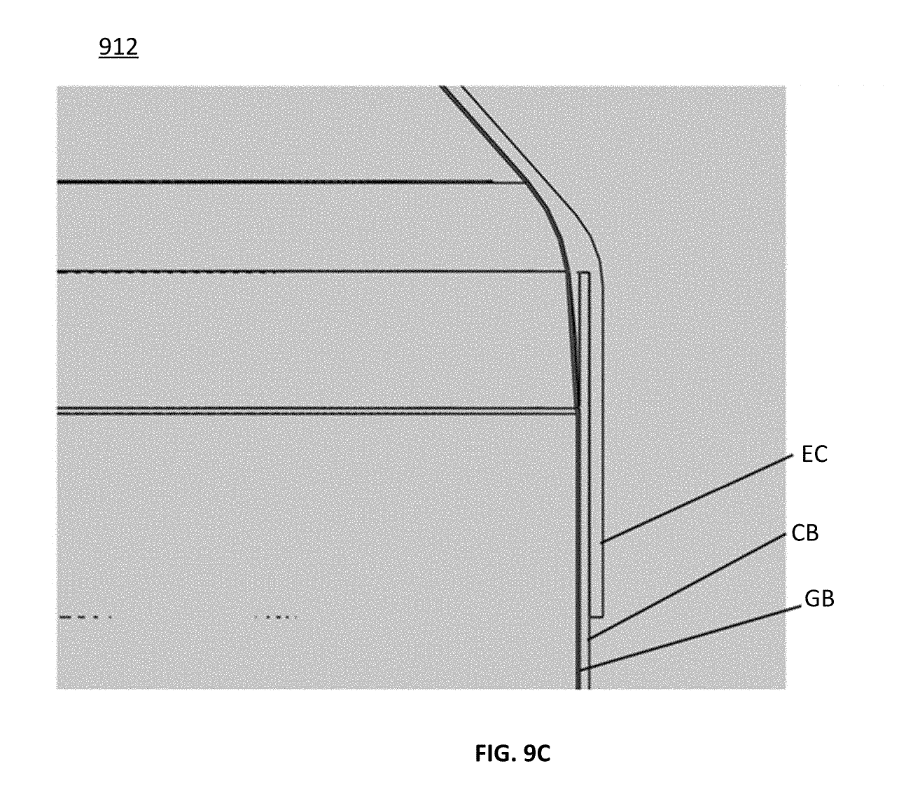

A support frame 910 according to an embodiment is illustrated in FIGS. 9A to 9C. As shown in FIG. 9A, support frame 910 is configured as a square pyramid, with side struts 912, peripheral struts 914, and diagonal struts 916. The side struts 912 are joined at a peak joint 913, the diagonal struts 916 are joined at a central joint 917, two peripheral struts 914, a side strut 912, and a diagonal strut 916 are joined at each of four corner joints 915.

One of the corner joints 915 is shown in closeup in FIG. 9B. As shown in FIG. 9B, the tapered end caps EC of each of the struts are joined by a coupler 920. Coupler 920 aligns the axes of the struts to ensure that the struts are primarily subjected to axial forces.

A partial cross-sectional view of strut 912, taken along line 9C-9C in FIG. 9B, is shown in FIG. 9C. As shown in FIG. 9C, the tapered end cap EC fits over the end of the thin walled cylindrical body CB of strut 912. The cylindrical body CB can be constructed of carbon fiber or any other suitable material. In some embodiments, the cylindrical body CB can be constructed of 5-50 layers of carbon fiber that can each be approximately 10-100 microns thick. The cylindrical body CB can be constructed of unidirectional and/or woven carbon fiber layers. Carbon fiber layers can be oriented and/or rotated as appropriate to provide the desired tensile, compressive, and/or hoop strength to the cylindrical body CB.

For example, a strut would can be 25 cm in diameter, 8 m long, with 500 micron thick walls, constructed of 10 laminations of Toray UT70 and Toray BT70 where the unidirectional UT70 is orientated axially and the bidirectional BT70 uses alternating orientations of −45 and +45 degrees from axial. This strut could be pressurized to approximately 15 atmospheres and could provide >30,000 N of compressive load bearing over 8 m of length and weigh less than 4.5 kg.

A gas bladder GB constructed of, for example, silicone, ultra high molecular weight polyethelene, or any other suitable material is contained within strut 912, and bears against cylindrical body CB and end cap EC. In some embodiments, the gas bladder GB can be formed by applying a sealant (e.g., a silicone sealant) to an internal surface of the cylindrical body CB.

End cap EC materials should be light and strong and can be constructed of aluminum, a titanium alloy, such as Ti-6Al-4V, or any other suitable material.

In some embodiments, the cylindrical body CB can be constructed of carbon fiber configured to resist pressure applied by the internal gas. Thus, the cylinder can function as a thin-walled pressure vessel. By aligning the fibers in axial and circumferential directions, the amount and weight of material used to construct the CB can be reduced and/or optimized. In some embodiments, the material used to construct the cylindrical body CB may have insufficient rigidity to maintain a circular cross-section without the pressurized gas. For example, the wall of the cylindrical body may deform or collapse under its own weight when not subjected to an internal pressure.

For struts subjected to compressive forces, tensile stresses induced by the gas pressure can partially or completely offset stresses associated with compressive loads. Thus, an appropriate gas pressure can be selected based on the maximum compressive load the strut 912 is designed to bear. Then, the cylindrical body CB materials, thickness and, for anisotropic materials, warp and weft pattern can be selected that have sufficient tensile strength to resist the selected gas pressure. When the compressive load is applied (e.g., as a result of a buoyant force and/or weight applied to the support frame 910), the pressure-induced longitudinal stresses can partially or completely offset forces and/or stresses associated with compression (e.g., associated with a superposition of buoyancy and weight). In this way, struts 910 can be designed to withstand internal pressures, rather than buckling loads, which can result in extremely light weight struts. In some instances, the structural materials alone (i.e., in the absence of pressurized gas) would insufficient to resist buckling.

In some embodiments, a support frame 910 may include some struts in compression and other struts in tension. In such an embodiment, compressive struts can be extremely low weight pressurized cylinders, while tension struts, where buckling is not the critical failure mode, can be constructed using other suitable means, or have lower internal pressures.

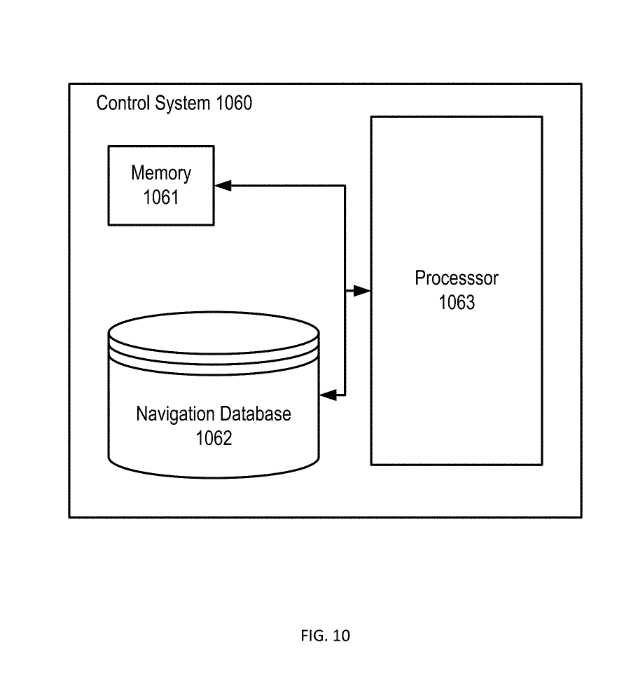

FIG. 10 is a schematic illustration of an optional control system 1060 according to an embodiment. The control system 1060 can include a primary flight control computer (including a processor 1063 and a memory 1061), pilot flight data and navigation displays, and control, communication and sensor interfaces. The primary flight control computer can act as a Flight Data Recorder (FDR) and Cockpit Voice Recorder (CVR). The primary flight control computer can also provides user specific features, such as pilot authorization, previous flight and route history, which can be stored in, for example, navigation database 1062. The control system 1060 can also provide full autopilot mode, hybrid mode, and/or manual mode. Full autopilot mode is used for drone operation only. In hybrid mode, pre-programmed flight plans (e.g., stored in navigation database 1062) are the primary control source with immediate manual override. In manual mode, the aircraft is under full pilot control. Pre-programmed flight plans can be loaded from previous flights or downloaded from external source. The ALTA control system can also monitor flight conditions and provide the pilot this data via the pilot flight data and navigation displays. In autopilot mode this information will be provided via the communication link.

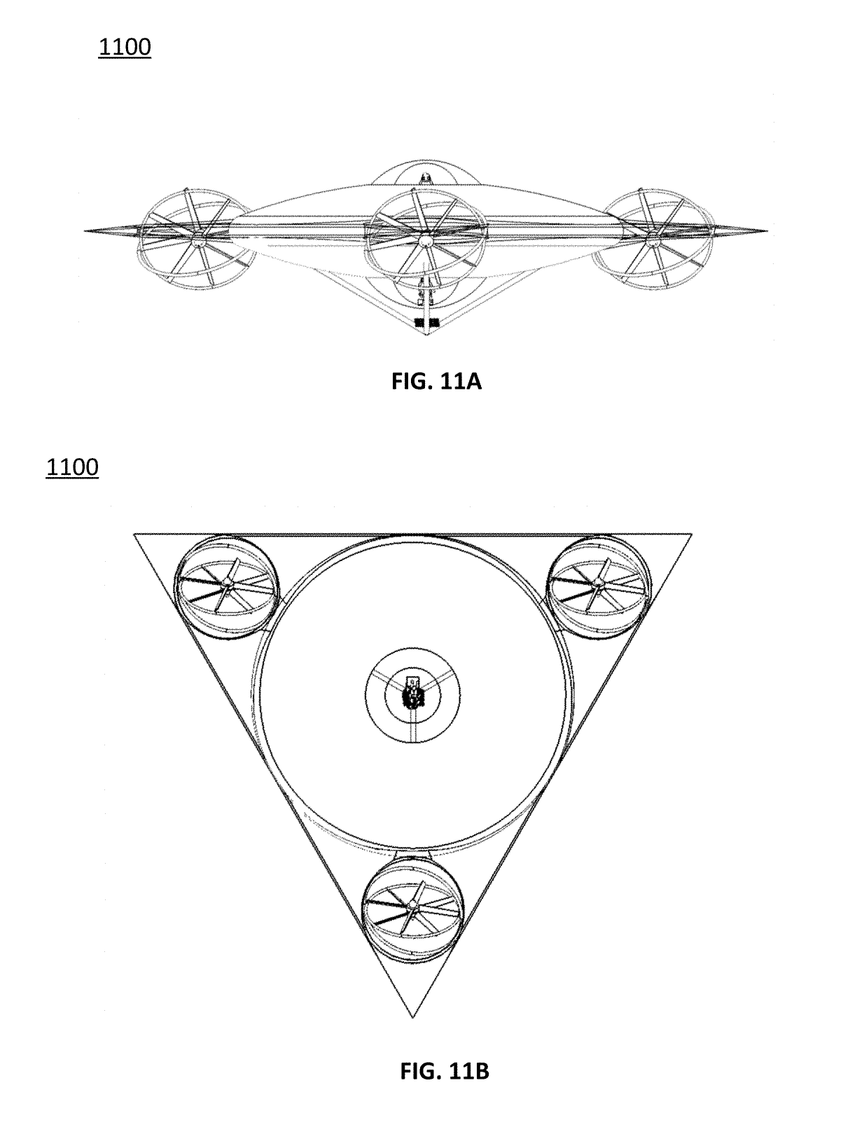

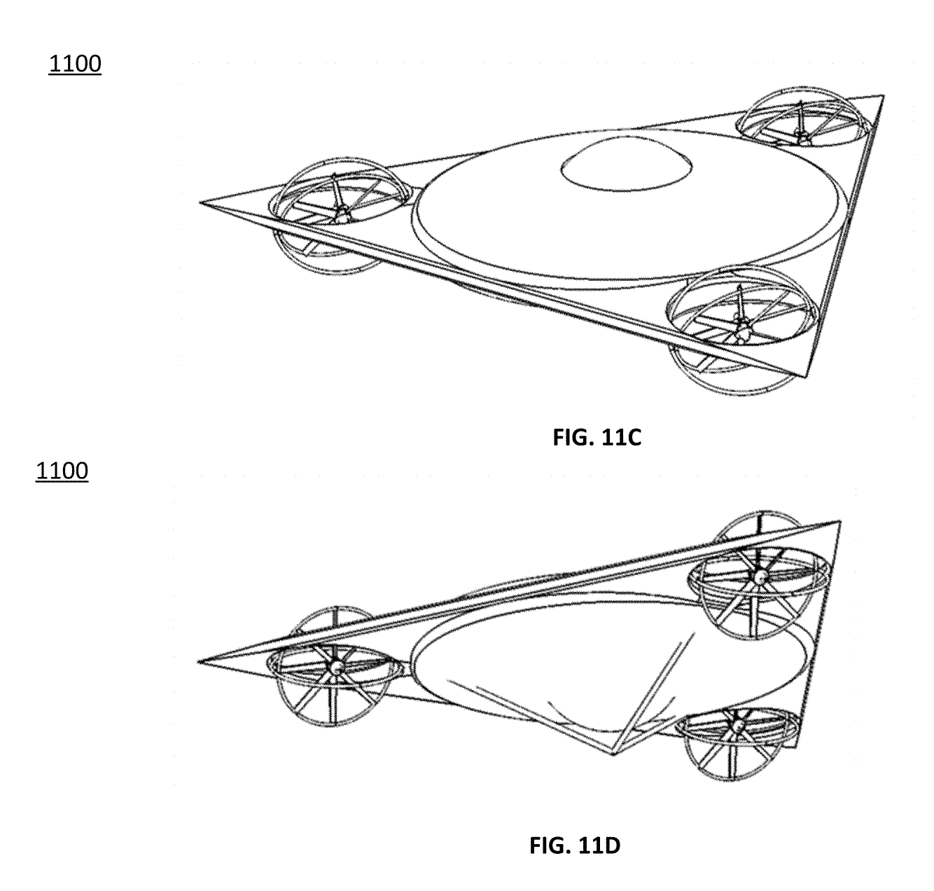

FIGS. 11A-D are a left view, top view, rear-perspective, and left-perspective, respectively of an aircraft 1100. Aircraft 1100 can be similar to any of the aircraft described above. Aircraft 1100, has a triangular planform and a tetrahedral support structure. Three propulsion units that are each gimbaled in two dimensions are disposed within a shell of the aircraft.

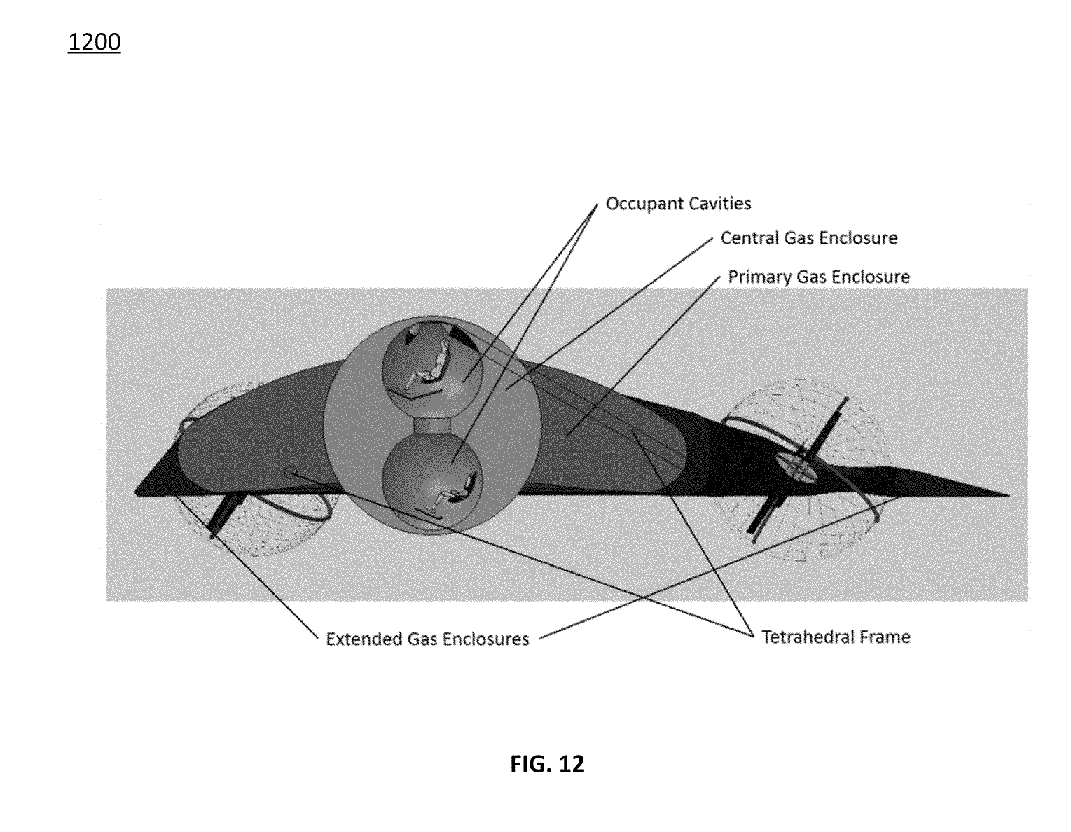

FIG. 12 is a cross sectional view of an aircraft 1200. Aircraft 1200 can be similar to any of the aircraft described above. FIG. 12 depicts occupant cavities, a central gas enclosure, a primary gas enclosure, extended gas enclosures, and a tetrahedral frame. FIG. 12 further depicts that the primary gas enclosure has an annular shape surrounding the substantially spherical central gas enclosure. The central gas enclosure in turn surrounds and protects the occupant cavities. The extended gas enclosure defines the shape of the exterior portions of the aircraft. In particular, the asymmetrical nature of the extended gas enclosures causes the aircraft to have a wing-like shape, which can induce lift and/or reduce drag. The extended gas enclosures can also be operable to deflect upwards and increase vertical drag in the event of a loss of power to a propulsion unit or loss of a gas enclosure.

As shown in FIG. 12, the frame of the aircraft has an apex above the occupant cavities. Thus, when the air propulsion units are in a horizontal configuration, the central gas enclosure is the lowermost portion of the aircraft. In the event of an uncontrolled or partially controlled landing, the central gas enclosure can be the first portion of the aircraft to contact the ground. The compliant nature of the central gas enclosure (and/or the primary and/or extended gas enclosures) can reduce the acceleration and impact forces associated with an uncontrolled or partially controlled landing.

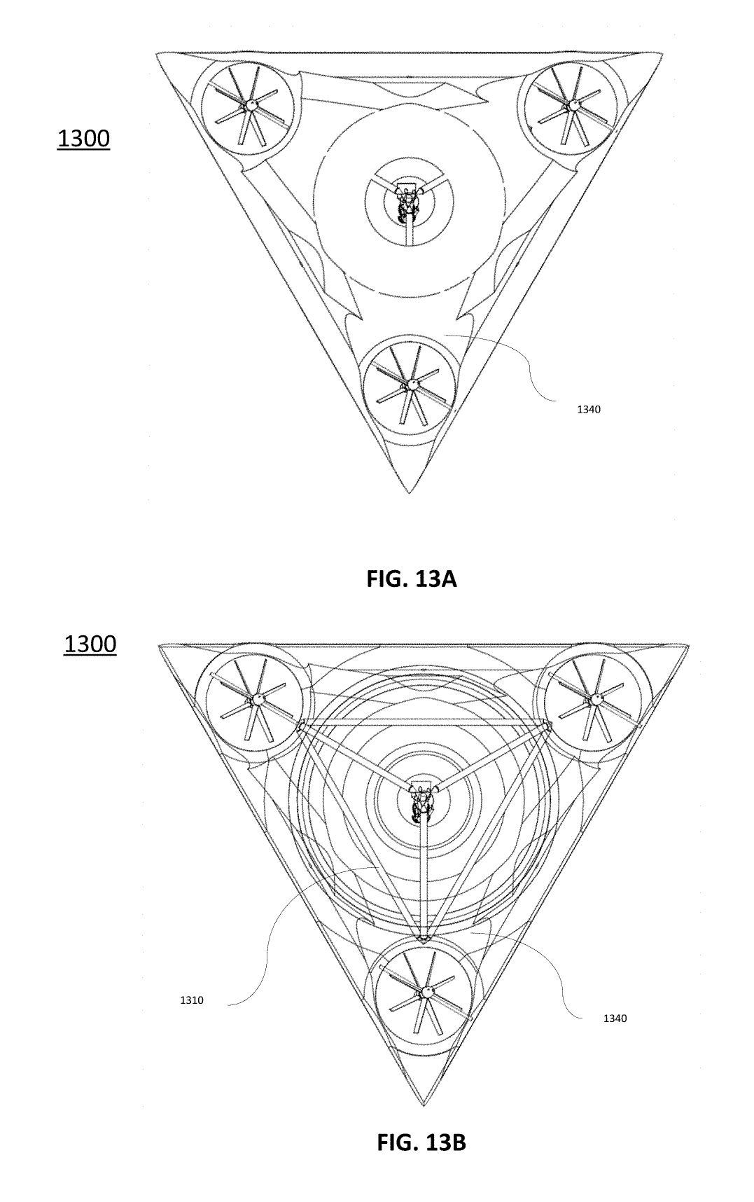

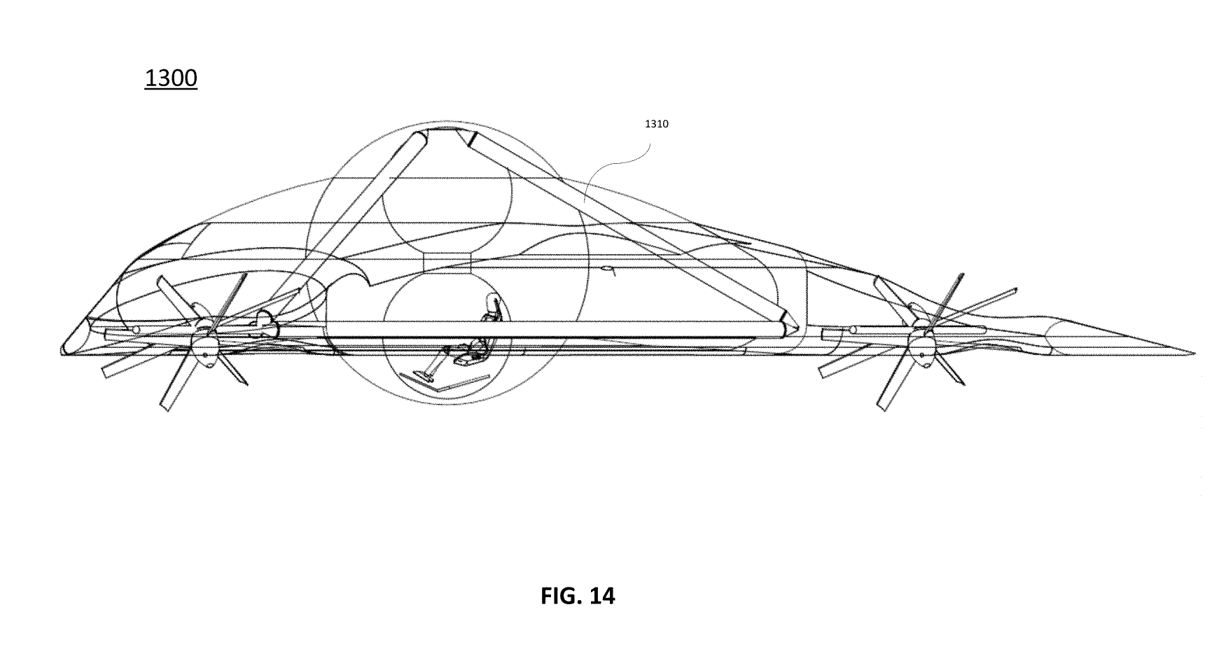

FIGS. 13A and 13B are top views of an aircraft 1300, according to an embodiment. Aircraft 1300 can be similar to any of the aircraft described herein. In FIG. 13A, a shell 1340 of the aircraft 1300 is opaque, while in FIG. 13B, the shell 1340 of the aircraft 1300 has been rendered translucent, revealing additional details of the frame 1310. FIG. 14 is a side view of the aircraft 1300, according to an embodiment.

Aircraft 1300 is a light-sport aircraft. Details of the component weights and performance of aircraft 1300 according to aa configuration is shown in Table 1 below.

TABLE 1
Vehicle Parameters

| | |
|---|---|
| 340 | Net vehicle weight - no pilot (kg) |
| 100 | Pilot weight (kg) |
| 440 | Gross vehicle weight - with pilot (kg) |
| 175 | Batteries (kg) |
| 165 | Gas compartments, propulsion units, support frame (kg) |
| 180 | Gas volume V (m³) |
| 182 | Buoyancy - helium gas, atmospheric air, at STP (kg) |
| 9 | Diameter of main body of annular gas compartment (m) |
| 4 | Overall height (m) |
| 38 | Cross section in vertical (Y-Z) plane (m²) |
| 144 | Cross section in horizontal (X-Y) plane (m²) |

Performance

| | |
|---|---|
| 49 | Range at top sustained speed (miles) |
| 41 | Top sustained speed (mph) |
| 99 | Max range at cruise speed (miles)* |
| 24 | Cruise speed (mph) |
| 1002 | Maximum lift capacity (kg) |

Safety
Failure of gas compartments (operation with propulsion units only)

| | |
|---|---|
| 820 | Lift capability without gas compartment (kg) |

Propulsion unit failure (gas lift forces only)

| | |
|---|---|
| 182 | Net buoyancy (no thrust from propulsion units) (kg) |
| 440 | Total maximum weight (kg) |
| 258 | kg heavier than air |
| 16.2 | terminal velocity (mph) |

*unlimited with solar option and sunny skies

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modifications are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

For example, although various embodiments have been described as having particular features and/or combinations of components, other embodiments are possible having any combination or sub-combination of any features and/or components from any of the embodiments described herein. In addition, the specific configurations of the various components can also be varied. For example, the size and specific shape of the various components can be different than the embodiments shown, while still providing the functions as described herein.

1. An aircraft, comprising:
a support frame having a longitudinal, lateral, and vertical axis;
at least one gas compartment coupled to the support frame, having a volume, and configured to contain a gas having a gas density less than the density of atmospheric air surrounding the aircraft during operation, the volume of the gas producing a gas lifting force;
a plurality of propulsion units coupled to the support frame, each propulsion unit configured to selectively produce a propulsive force with a thrust vector, with a magnitude up to a maximum propulsive force and with a direction having a non-zero component along the vertical axis of the support frame, the plurality of propulsion units having a maximum collective propulsive force component along the vertical axis that defines a maximum vertical propulsion force;
an energy store coupled to the plurality of propulsion units to provide energy to the propulsion units;
a payload station coupled to the support frame and configured to support a payload having a maximum weight;
the maximum gross weight of the aircraft, including the weight of the support frame, the at least one gas compartment, the plurality of propulsion units, the energy store, the payload station, and the maximum weight of the payload, being greater than either the gas lifting force or the maximum vertical propulsion force and less than the sum of the gas lifting force and the maximum vertical propulsion force.

2. The aircraft of claim 1, wherein the payload can include a human passenger, and the payload station is configured to support the passenger.

3. (canceled)

4. The aircraft of claim 1, wherein at least one of the plurality of propulsion units has a thrust vector with a direction that is variable about at least one axis of the support frame.

5. The aircraft of claim 1, wherein the at least one of the plurality of propulsion units has a thrust vector with a direction that is variable about at least two axes of the support frame.

6. The aircraft of claim 1, wherein the thrust vector of at least one of the plurality of propulsion units has a non-zero component along the longitudinal axis of the support frame, the plurality of propulsion units having a maximum collective propulsive force component along the longitudinal axis that defines a maximum horizontal propulsion force to produce forward movement of the aircraft.

7. The aircraft of claim 1, further comprising a control system coupled to the plurality of propulsion units and configured to provide control inputs to the plurality of propulsion units to selectively change the thrust vector produced by each of the plurality of propulsion units.

8. (canceled)

9. The aircraft of claim 1, wherein each of the propulsion units includes a rotor that produces the propulsive force by rotation through a stream of atmospheric air.

10. The aircraft of claim 1, wherein the maximum collective propulsive force is a nominal maximum, the plurality of propulsion units being capable of temporarily exceeding the nominal maximum collective propulsive force and producing a force greater than the weight of the maximum weight of the payload, exceeding the nominal maximum collective propulsive force unsuitable for sustained operation.

11. The aircraft of claim 1, wherein the energy is in the form of a chemical fuel, at least one of the propulsion units includes a combustion engine, and the energy store includes one or more tanks to contain the fuel.

12. The aircraft of claim 1, wherein the energy is electrical energy, at least one of the propulsion units includes an electric motor.

13.-14. (canceled)

15. An aircraft, comprising:
a support frame;
an occupant cavity coupled to the support frame; and
a gas compartment coupled to the support frame, at least a portion of the gas compartment disposed below a bottom of the support frame and a bottom of the occupant cavity, the gas compartment configured to exert a buoyant force on the support frame, the gas compartment being compliant and a structure which first contacts the ground in an uncontrolled or partially controlled landing.

16. (canceled)

17. The aircraft of claim 15, wherein the gas is compartment configured to produce vertical drag when the aircraft descends, the drag and the compliance collectively limiting an acceleration associated with an uncontrolled or partially controlled landing to fewer than 5 g.

18. The aircraft of claim 15, wherein the gas compartment is configured to prevent the support frame and the occupant cavity from contacting the ground during an uncontrolled or partially controlled landing.

19. The aircraft of claim 15, further comprising a plurality of propulsion units coupled to the support frame, each propulsion unit configured to selectively produce a propulsive force with a thrust vector having a non-zero component along a vertical axis of the support frame, the gas compartment configured to prevent any propulsion units from the plurality of propulsion units from contacting the ground during an uncontrolled or partially controlled landing.

20. The aircraft of claim 15, wherein the gas compartment has a compliance of 9 MPa⁻¹ or greater.

21. (canceled)

22. An aircraft, comprising:
a support frame including a plurality of struts, each strut from the plurality of struts including:
a cylinder wall with a thickness at least an order of magnitude smaller than a diameter of the strut,
two end caps coupled to opposite ends of the strut,
a pressurized gas contained within an interior volume of the strut; and
a gas compartment coupled to the support frame and configured to exert a buoyant force on the support frame.

23. The aircraft of claim 22, wherein each strut from the plurality struts includes a gas bladder disposed within the cylindrical wall containing the pressurized gas.

24. (canceled)

25. The aircraft of claim 22, wherein, in the absence of the pressurized gas, a strut from the plurality of struts has a stiffness insufficient to prevent buckling when the support frame is subjected to the buoyant force and a weight of the aircraft.

26.-27. (canceled)

28. The aircraft of claim 22, wherein the pressurized gas induces a longitudinal tensile stress in a strut from the plurality of struts greater than a sum of compressive forces associated with flight divided by the cross sectional area of the strut.

29. (canceled)

30. The aircraft of claim 22, wherein the buoyant force and weight of the aircraft applies a tension load to a first strut from the plurality of struts and a compressive load to a second strut from the plurality of struts, pressurized gas within the first strut having a higher pressure than pressurized gas within the second strut.

31. The aircraft of claim 22, wherein the buoyant force and a weight of the aircraft places a strut from the plurality of struts in compression, the pressurized gas inducing a longitudinal tensile stress in the strut offsetting the compression.

32. (canceled)
